(19) United States
(12) Patent Application Publication
(10) Pub. No.: US 2026/0031493 A1
(43) Pub. Date: Jan. 29, 2026

(54) BUS BAR ASSEMBLIES WITH ARCHED BUS BAR PLATES

(71) Applicant: FORD GLOBAL TECHNOLOGIES, LLC, Dearborn, MI (US)

(72) Inventors: John Marshall PENNEY, Livonia, MI (US); Steve DROSTE, Canton, MI (US); Marc BRONZETTI, Berkley, MI (US)

(21) Appl. No.: 18/780,848

(22) Filed: Jul. 23, 2024

(51) Int. Cl. H01M 50/516; B60L 50/64; H01M 50/211; H01M 50/503; H01M 50/507

(52) U.S. Cl. CPC H01M 50/516; B60L 50/64; H01M 50/211; H01M 50/503; H01M 50/507; H01M 2220/20

(57) ABSTRACT

Bus bar assemblies are provided for electrically connecting battery cells within a battery array of a traction battery pack. An exemplary bus bar assembly may include a ladder frame and a bus bar plate that is mounted to the ladder frame. In some implementations, the bus bar plate is an arched bus bar plate. The bus bar plate may provide suitable welding surfaces for joining both battery cell tab terminals and sense leads to the bus bar plate. The battery cell tab terminals may be joined to the bus bar plate without positioning the bus bar plate perpendicular to the tab terminals and without bending the tab terminals.

### TECHNICAL FIELD

This disclosure relates generally to traction battery packs, and more particularly to bus bar assemblies for electrically connecting battery cells within battery arrays of traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a plurality of battery cells arranged between a first bus bar assembly and a second bus bar assembly. The first bus bar assembly and the second bus bar assembly each include a ladder frame and a bus bar plate mounted to the ladder frame. The bus bar plate includes a first welding leg, a second welding leg, and a bridging section that extends between the first welding leg and the second welding leg.

In a further non-limiting embodiment of the foregoing traction battery pack, the plurality of battery cells includes pouch battery cells.

In a further non-limiting embodiment of either of the foregoing traction battery packs, the ladder frame is made of a thermoplastic material and includes a plurality of cell tab openings each sized to receive a tab terminal of one or more of the plurality of battery cells.

In a further non-limiting embodiment of all of the foregoing traction battery packs, a first tab terminal of a first battery cell of the plurality of battery cells is received through a first cell tab opening of the ladder frame, and a second tab terminal of a second battery cell of the plurality of battery cells is received through the first cell tab opening.

In a further non-limiting embodiment of all of the foregoing traction battery packs, the first tab terminal is joined to a first side wall of the first welding leg by a first weld, and the second tab terminal is joined to a second side wall of the first welding leg by a second weld.

In a further non-limiting embodiment of all of the foregoing traction battery packs, the first side wall of the first welding leg extends in parallel with the first tab terminal, and the second side wall of the first welding leg extends in parallel with the second tab terminal.

In a further non-limiting embodiment of all of the foregoing traction battery packs, a third tab terminal of a third battery cell of the plurality of battery cells is received through a second cell tab opening of the ladder frame, and a fourth tab terminal of a fourth battery cell of the plurality of battery cells is received through the second cell tab opening.

In a further non-limiting embodiment of all of the foregoing traction battery packs, the third tab terminal is joined to a first side wall of the second welding leg by a third weld, and the fourth tab terminal is joined to a second side wall of the second welding leg by a fourth weld.

In a further non-limiting embodiment of all of the foregoing traction battery packs, the first side wall of the second welding leg extends in parallel with the third tab terminal, and the second side wall of the second welding leg extends in parallel with the fourth tab terminal.

In a further non-limiting embodiment of all of the foregoing traction battery packs, the bridging section is arched or curved.

In a further non-limiting embodiment of all of the foregoing traction battery packs, the bridging section is flat or non-curved.

In a further non-limiting embodiment of all of the foregoing traction battery packs, the bus bar plate includes a third welding leg and a second bridging section that extends between the second welding leg and the third welding leg.

In a further non-limiting embodiment of all of the foregoing traction battery packs, a flexible circuit board is mounted to an upper beam section of the ladder frame.

In a further non-limiting embodiment of all of the foregoing traction battery packs, a sense lead of the flexible circuit board is joined to the bridging section of the bus bar plate by a weld.

A traction battery pack according to another exemplary aspect of the present disclosure includes, among other things, a bus bar assembly for electrically connecting a grouping of battery cells. The bus bar assembly includes a ladder frame and an arched bus bar plate mounted to the ladder frame.

In a further non-limiting embodiment of the foregoing traction battery pack, the arched bus bar plate includes a first welding leg, a second welding leg, and a bridging section that extends between the first welding leg and the second welding leg.

In a further non-limiting embodiment of either of the foregoing traction battery packs, a first battery cell tab terminal that is received through a first cell tab opening of the ladder frame extends in parallel with the first welding leg, and a second battery cell tab terminal that is received through a second cell tab opening of the ladder frame extends in parallel with the second welding leg.

In a further non-limiting embodiment of any of the foregoing traction battery packs, the first battery cell tab terminal is joined to the first welding leg by a first weld, and the second battery cell tab terminal is joined to the second welding leg by a second weld.

In a further non-limiting embodiment of any of the foregoing traction battery packs, a flexible circuit board is mounted to the ladder frame. A sense lead of the flexible circuit board is joined to the bridging section of the arched bus bar plate by a weld.

In a further non-limiting embodiment of any of the foregoing traction battery packs, the first welding leg and the second welding leg each provides two welding surfaces for joining tab terminals of the grouping of battery cells to the arched bus bar plate.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates an exemplary battery array of the traction battery pack of FIG. 2.

FIGS. 4, 5, and 6 illustrate select features associated with a bus bar assembly of the battery array of FIG. 3.

FIG. 7 illustrates a bus bar plate of a bus bar assembly.

FIG. 8 illustrates another exemplary bus bar plate.

### DETAILED DESCRIPTION

This disclosure details bus bar assemblies for electrically connecting battery cells within a battery array of a traction battery pack. An exemplary bus bar assembly may include a ladder frame and a bus bar plate that is mounted to the ladder frame. In some implementations, the bus bar plate is an arched bus bar plate. The bus bar plate may provide suitable welding surfaces for joining both battery cell tab terminals and sense leads to the bus bar plate. The battery cell tab terminals may be joined to the bus bar plate without positioning the bus bar plate perpendicular to the tab terminals and without bending the tab terminals. These and other features are discussed in greater detail in the following paragraphs of this detailed description.

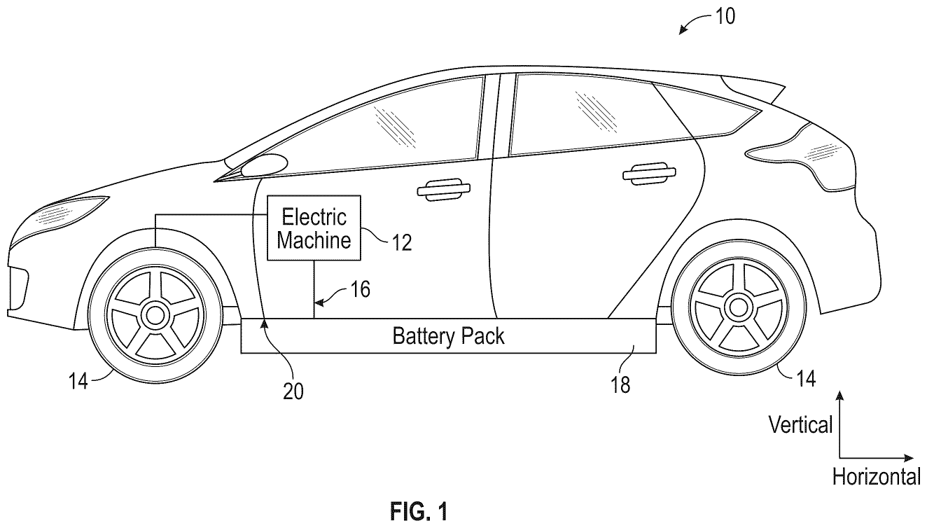

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

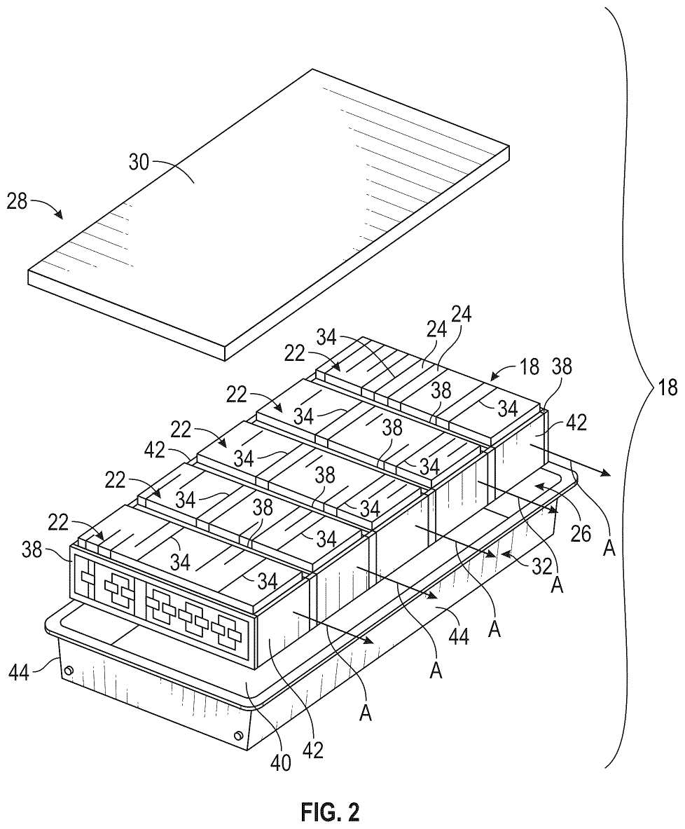

FIG. 2 illustrates additional details associated with the traction battery pack 18 of the electrified vehicle 10 of FIG. 1. The traction battery pack 18 may include one or more battery arrays 22 (e.g., battery modules or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The one or more battery arrays 22 of the traction battery pack 18 may each include a plurality of battery cells 24 that store energy for powering various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 2.

In an embodiment, the battery cells 24 are lithium-ion pouch cells. However, battery cells having other geometries and/or chemistries (nickel-metal hydride, lead-acid, etc.) could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 of the traction battery pack 18 may include an enclosure cover 30 and an enclosure tray 32. The enclosure cover 30 may be secured (e.g., bolted, welded, adhered, etc.) to the enclosure tray 32 to provide the interior area 26 for housing the battery arrays 22 and other battery internal components of the traction battery pack 18.

The battery cells 24 of each battery array 22 may be stacked together and arranged along a stack axis A. One or more thermal barrier assemblies 34 may be arranged along the respective stack axis A of each battery array 22. The thermal barrier assemblies 34 may compartmentalize each battery array 22 into two or more groupings or compartments. Each compartment may hold one or more of the battery cells 24 of the battery array 22.

The battery cells 24 of each battery array 22 may be arranged to extend between a pair of bus bar assemblies 38. Among other functions, the bus bar assemblies 38 may be configured to electrically connect the battery cells 24 within each battery array 22 and at least partially delineate the battery arrays 22 from one another within the interior area 26 of the enclosure assembly 28.

A vertically lower side of each battery array 22 may interface with a heat exchanger plate 40 that is positioned against a floor of the enclosure tray 32. However, in another embodiment, the heat exchanger plate 40 could be omitted and the vertically lower side of each battery array 22 may be received in direct contact with the floor of the enclosure tray 32. Vertical and horizontal, for purposes of this disclosure, are with reference to ground and a general orientation of traction battery pack 18 when installed on the electrified vehicle 10 of FIG. 1.

Each battery array 22 may be arranged to extend along its respective stack axis A between opposing end plates 42. The end plates 42 may be positioned between the ends of the battery arrays 22 and longitudinally extending side walls 44 of the enclosure tray 32. The end plates 42 may therefore extend along axes that are substantially transverse (e.g. perpendicular) to the stack axes A of the battery arrays 22.

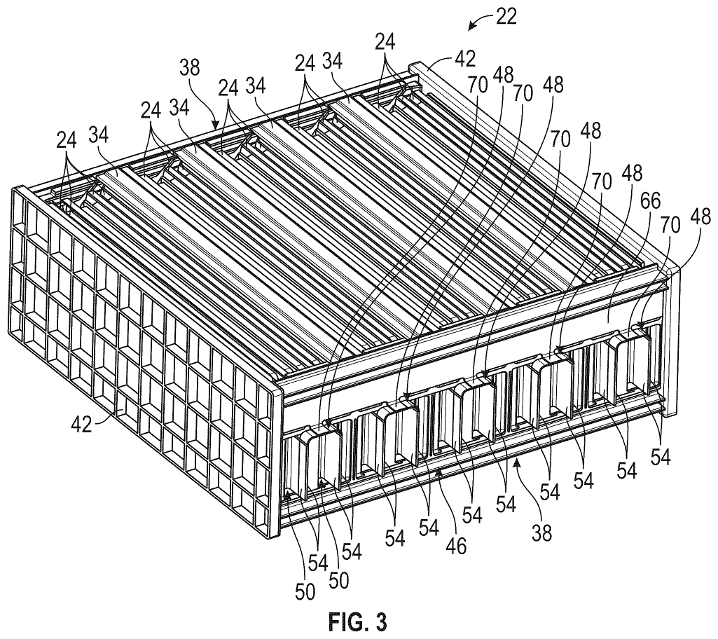

FIGS. 3, 4, 5, and 6 illustrate additional details associated with the bus bar assemblies 38 of the battery arrays 22 of the traction battery pack 18. Each bus bar assembly 38 may include a ladder frame 46 and one or more bus bar plates 48. As further discussed below, each bus bar plate 48 may provide multiple weld surfaces for electrically connecting battery cells 24 within each battery array 22.

The ladder frame 46 of each bus bar assembly 38 may be either a unitary or a multi-piece injection molded structure. The ladder frame 46 may be made of any suitable thermoplastic material.

The ladder frame 46 may include a plurality of cell tab openings 50. The cell tab openings 50 may be elongated slots formed through the ladder frame 46. A column 52 of the ladder frame 46 may vertically extend between adjacent cell tab openings 50. The total numbers of cell tab openings 50 and columns 52 provided within the ladder frame 46 can vary and is therefore not intended to limit this disclosure.

Each cell tab opening 50 may be configured to accommodate one or more cell tab terminals 54 of one or more battery cells 24 of the battery array 22. Each cell tab terminal 54 may protrude outwardly from a housing of one of the battery cells 24. In an embodiment, each battery cell 24 includes a pair of cell tab terminals 54, with one of the cell tab terminals 54 projecting from a first side of the housing and providing a positive terminal of the battery cell 24, and the other cell tab terminal 54 projecting from an opposite side of the housing and providing a negative terminal of the battery cell 24. The positive terminals can be electrically connected by the bus bar assembly 38 located at a first side of the battery array 22, and the negative terminals can be electrically connected by the bus bar assembly 38 located on a second, opposite side of the battery array 22. However, other configurations are further contemplated within the scope of this disclosure.

The bus bar plates 48 may be metallic components of the bus bar assemblies 38. In an embodiment, the bus bars plates 48 are made of copper or aluminum. However, other materials or combinations of materials are contemplated within the scope of this disclosure.

The bus bar plates 48 may be mounted to the ladder frame 46 in any suitable manner. In an embodiment, the bus bar plates 48 are heat staked to the ladder frame 46. In another embodiment, the bus bar plates 48 are clipped to the ladder frame 46. In yet another embodiment, the bus bar plates 48 are adhered to the ladder frame 46. However, other attachment methodologies or combinations of these and/or other attachment methodologies could be utilized within the scope of this disclosure.

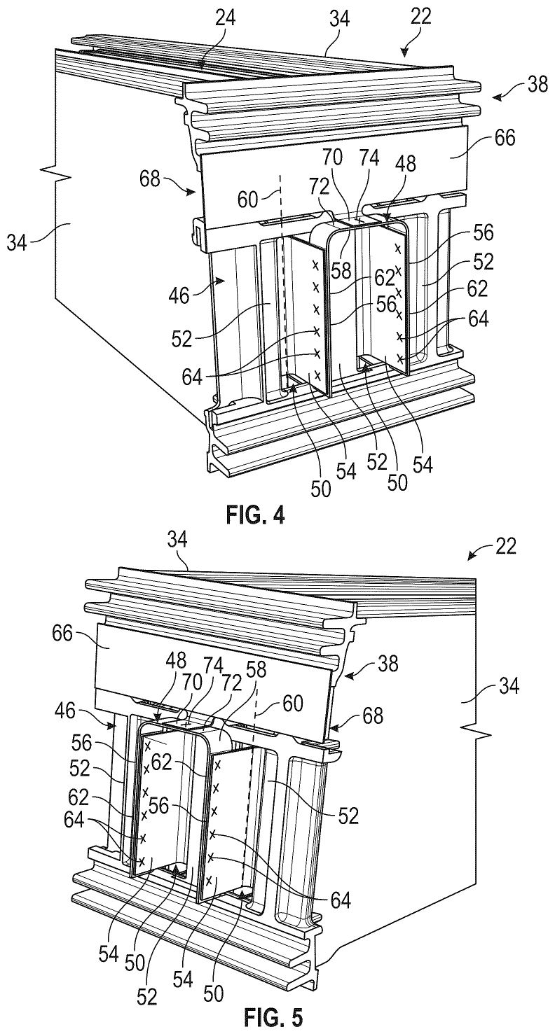

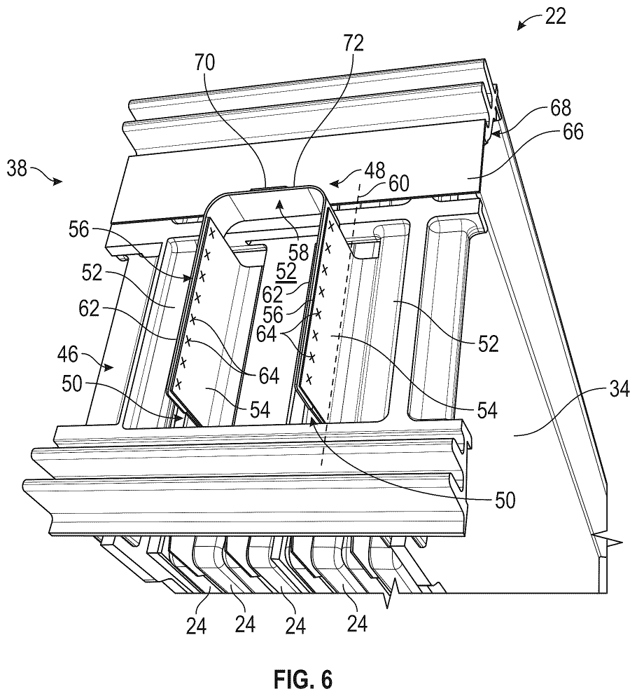

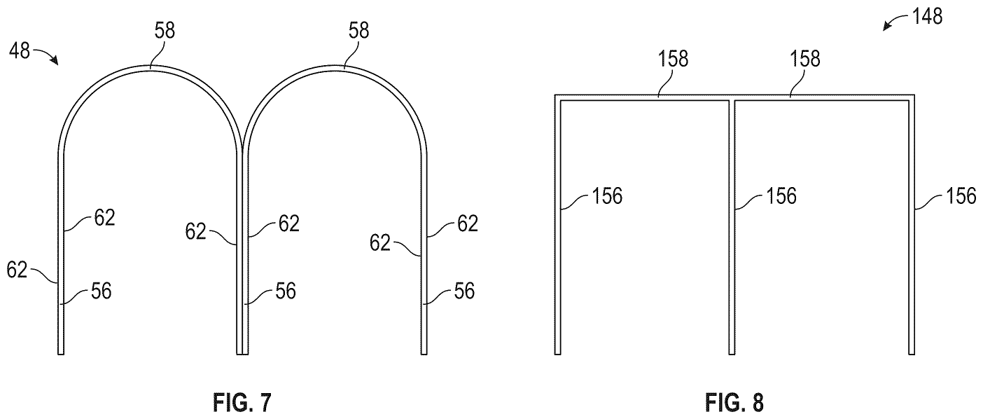

Each bus bar plate 48 may include at least two welding legs 56 and at least one bridging section 58. In an embodiment, each bus bar plate 48 includes a pair of welding legs 56 and a bridging section 58 that extends between the welding legs 56 (sec, e.g., FIGS. 4-6). In another embodiment, each bus bar plate 48 includes three welding legs 56 and two bridging sections 58 that each connect between adjacent pairs of the welding legs 56 (see, e.g., FIGS. 7 and 8). However, additional configurations are contemplated within the scope of this disclosure, and it would be recognized by persons of ordinary skill in the art having the benefit of this disclosure that the bus bar plates could include any amount of welding legs and bridging sections.

The welding legs 56 may extend in parallel with one another and in parallel with a longitudinal axis 60 of the cell tab openings 50. The bridging section(s) 58 may extend at a transverse angle relative to the welding legs 56 and may connect upper sections of the welding legs 56. In an embodiment, the bridging section 58 is an arched or curved section of the bus bar plate 48. The bus bar plate 48 may therefore be an arched bus bar plate.

Each bus bar plate 48 may be positioned relative to the ladder frame 46 such that one of the welding legs 56 is located directly adjacent (here, in front of or directly outward of) one of the cell tab openings 50 of the ladder frame 46, and the other welding leg 56 is located directly adjacent (here, in front of or directly outward of) an additional cell tab opening 50 of the ladder frame 46. Each welding leg 56 may therefore be positioned to interface with one or more of the tab terminals 54 that have been inserted through the cell tab openings 50 of the ladder frame 46.

Each welding leg 56 of the bus bar plates 48 may include opposing side walls 62 that each extend in parallel with the tab terminals 54. Each side wall 62 provides a suitable welding surface for joining (e.g., welding) the tab terminals 54 to the bus bar plates 48. For example, one tab terminal 54 may be secured to each side wall 62 of each welding leg 56 by one or more welds 64 (e.g., laser welds). The tab terminals 54 of the battery cells 24 of the battery arrays 22 may therefore be joined to the bus bar plates 48 without the need to position the bus bar plates 48 at a perpendicular angle relative to the tab terminals 54 and without the need to bend the tab terminals 54 over the bus bar plate 48, thereby simplifying battery array assembly and welding operations.

The bus bar plate 48 shown in FIGS. 4-6 includes a total of four welding surfaces (e.g., two on each welding leg 56). However, the bus bar plate 48 could be configured to include three or more welding legs 56 to provide six or more suitable welding surfaces (see, e.g., the embodiments of FIGS. 7-8) for joining tab terminals 54 to the bus bar plate 48.

Each bus bar assembly 38 may additionally include a flexible circuit board 66 that is configured for monitoring and communicating data (e.g., temperature, voltage, current, state of charge, etc.) associated with the battery cells 24 of the battery array 22 as part of a battery management system of the traction battery pack 18. The flexible circuit board 66 may include a plurality of sense leads 70 that can collect the data being monitored by the flexible circuit board 66.

The flexible circuit board 66 may be mounted to an upper beam section 68 of the ladder frame 46. The upper beam section 68 may be positioned vertically above the portion of the ladder frame 46 that includes the cell tab openings 50 and the columns 52, for example.

When mounted to the ladder frame 46, the bridging section(s) 58 of each bus bar plate 48 may establish an upper plateau 72 of the bus bar plate 48. The upper plateau 72 provides a suitable welding surface for joining (e.g., welding) one or more sense leads 70 to the bus bar plate 48. For example, the sense lead 70 may be secured to the bridging section 58 by one or more welds 74 (e.g., laser welds).

FIG. 8 illustrates another exemplary bus bar plate 148 that could be employed within the bus bar assemblies 38 discussed above. The bus bar plate 148 may include two or more welding legs 156 (three shown) and one or more bridging sections 158 (two shown). The welding legs 156 may extend in parallel with one another, and the bridging section(s) 158 may extend transversely relative to the welding legs 156 to connect upper sections thereof. In this particular embodiment, the bridging section(s) 158 is a flat or non-curved section of the bus bar plate 148 rather than an arched section.

The exemplary bus bar assemblies of this disclosure include bus bar plates that can be arranged to extend in parallel with battery cell tab terminals of a grouping of battery cells. The bus bar plates provide suitable welding surfaces for joining the tab terminals (and sense leads of a battery monitoring system) to the bus bar plate without positioning the bus bar plates perpendicularly to the tab terminals and without bending the tab terminals over the bus bar plates. The proposed bus bar assemblies therefore simplify battery array assembly and welding processes.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a plurality of battery cells arranged between a first bus bar assembly and a second bus bar assembly; and
the first bus bar assembly and the second bus bar assembly each including a ladder frame and a bus bar plate mounted to the ladder frame,
wherein the bus bar plate includes a first welding leg, a second welding leg, and a bridging section that extends between the first welding leg and the second welding leg.

2. The traction battery pack as recited in claim 1, wherein the plurality of battery cells includes pouch battery cells.

3. The traction battery pack as recited in claim 1, wherein the ladder frame is comprised of a thermoplastic material and includes a plurality of cell tab openings each sized to receive a tab terminal of one or more of the plurality of battery cells.

4. The traction battery pack as recited in claim 1, wherein a first tab terminal of a first battery cell of the plurality of battery cells is received through a first cell tab opening of the ladder frame, and a second tab terminal of a second battery cell of the plurality of battery cells is received through the first cell tab opening.

5. The traction battery pack as recited in claim 4, wherein the first tab terminal is joined to a first side wall of the first welding leg by a first weld, and the second tab terminal is joined to a second side wall of the first welding leg by a second weld.

6. The traction battery pack as recited in claim 5, wherein the first side wall of the first welding leg extends in parallel with the first tab terminal, and the second side wall of the first welding leg extends in parallel with the second tab terminal.

7. The traction battery pack as recited in claim 5, wherein a third tab terminal of a third battery cell of the plurality of battery cells is received through a second cell tab opening of the ladder frame, and a fourth tab terminal of a fourth battery cell of the plurality of battery cells is received through the second cell tab opening.

8. The traction battery pack as recited in claim 7, wherein the third tab terminal is joined to a first side wall of the second welding leg by a third weld, and the fourth tab terminal is joined to a second side wall of the second welding leg by a fourth weld.

9. The traction battery pack as recited in claim 8, wherein the first side wall of the second welding leg extends in parallel with the third tab terminal, and the second side wall of the second welding leg extends in parallel with the fourth tab terminal.

10. The traction battery pack as recited in claim 1, wherein the bridging section is arched or curved.

11. The traction battery pack as recited in claim 1, wherein the bridging section is flat or non-curved.

12. The traction battery pack as recited in claim 1, wherein the bus bar plate includes a third welding leg and a second bridging section that extends between the second welding leg and the third welding leg.

13. The traction battery pack as recited in claim 1, comprising a flexible circuit board mounted to an upper beam section of the ladder frame.

14. The traction battery pack as recited in claim 13, wherein a sense lead of the flexible circuit board is joined to the bridging section of the bus bar plate by a weld.

15. A traction battery pack, comprising:
a bus bar assembly for electrically connecting a grouping of battery cells, wherein the bus bar assembly includes:
a ladder frame; and
an arched bus bar plate mounted to the ladder frame.

16. The traction battery pack as recited in claim 15, wherein the arched bus bar plate includes a first welding leg, a second welding leg, and a bridging section that extends between the first welding leg and the second welding leg.

17. The traction battery pack as recited in claim 16, wherein a first battery cell tab terminal that is received through a first cell tab opening of the ladder frame extends in parallel with the first welding leg, and a second battery cell tab terminal that is received through a second cell tab opening of the ladder frame extends in parallel with the second welding leg.

18. The traction battery pack as recited in claim 17, wherein the first battery cell tab terminal is joined to the first welding leg by a first weld, and the second battery cell tab terminal is joined to the second welding leg by a second weld.

19. The traction battery pack as recited in claim 16, comprising a flexible circuit board mounted to the ladder frame, wherein a sense lead of the flexible circuit board is joined to the bridging section of the arched bus bar plate by a weld.

20. The traction battery pack as recited in claim 16, wherein the first welding leg and the second welding leg each provides two welding surfaces for joining tab terminals of the grouping of battery cells to the arched bus bar plate.
